(19) United States
(12) Patent Application Publication
(10) Pub. No.: US 2012/0262808 A1
(43) Pub. Date: Oct. 18, 2012

(54) Multiple-layer radiation absorber

(76) Inventor: Robert Baker, Raya del Ray, CA (US)

(21) Appl. No.: 13/088,784

(22) Filed: Apr. 18, 2011

(51) Int. Cl. G02B 5/22

(52) U.S. Cl. 359/885

(57) ABSTRACT

An apparatus or structure is provided for absorbing incident radiation, either electromagnetic or sound, comprising a multiple-layer composite means utilizing electromagnetic- or sound-radiation absorbing and partially transmitting layers on a substrate of conventional electromagnetic- or sound-absorbing and partially reflecting material, which act in concert to absorb a significant amount of the incident electromagnetic or sound radiation. A metamaterial [MM] means, configured for a specific electromagnetic or sound radiation frequency band that absorbs incident electromagnetic or sound radiation directed to a substrate of conventional electromagnetic-radiation absorbing or acoustical absorbing material, such as an array of pyramidal foam absorbers. Such a substrate may outgas into a high vacuum and reduce the capability of the vacuum-producing equipment to achieve such a high vacuum. The layers above this lowest substrate will also serve to seal the absorbing and reflecting substrate from the external vacuum and, therefore, not reduce the capability of any vacuum-producing equipment.

### REFERENCES CITED

### U.S. Patent Documents

| | | |
|---|---|---|
| 4,559,255 | December 1985 | Shimode, et al. |
| 6,419,772 | July 2002 | Takamatsu, et al. |
| 6,756,932 | June 2004 | Barker, et al. |
| 6,853,062 | February 2005 | Saito |
| 6,943,731 | September 2005 | Killen, et al. |
| 7,301,493 | November 2007 | Canales, et al |
| 7,405,866 | July 2008 | Kuekes, et al. |

### Other References

Chen, Huanvang and Chan, C. T. (2007), “Acoustic cloaking in three dimensions using acoustic metamaterials,” Appl. Phys. Lett. 91, 183518

Landy. N. I., Sajuyigbe, S., Mock, J. J., Smith, D. R. and Padilla (2008), “Perfect Metamaterial Absorber,” Physical Review Letters 100, pp. 207402-1-4, May 23.

Service, R. F. (2010), “Next wave of metamaterials hopes to fuel the revolution,” Science 327, pp. 138-139.

Baker, R. M L, Jr. (2010), “Utilization of High-Frequency Gravitational Waves for Aerospace System and Technology,” Proceedings of the Seventh Annual AIAA Southern California Aerospace Systems and Technology (ASAT) Conference Santa Ana, Calif., May 1.

R. M L Baker, Jr. (2011), “The Li-Baker High-Frequency Relic Gravitational Wave Detector,” PowerPoint Slide Presentation in the Proceedings of the Space, Propulsion and Energy Sciences International Forum (SPESIF 2011, University of Maryland), Edited by Glen Robertson. (Paper 008), March 15-17. Available at: http://www.gravwave.com/docs/New%20008%20SPESIF%202011.ppt

R. Clive Woods, Robert M L Baker, Jr., Fangyu Li, Gary V. Stephenson, Eric W. Davis and Andrew W. Beckwith (2011), “A new theoretical technique for the measurement of high-frequency relic gravitational waves,” Journ Mod. Phys. 2, No. 5 http://vixra.org/abs/1010.0062 and http://www.gravwave.com/docs/Theoretical%20technique%20for%20the%20measurement%20of%2OHFGWs%20V3.pdf

### FIELD OF THE INVENTION

The present invention relates to a method of and a structure for absorbing electromagnetic or sound radiation of any given wavelength or wavelength band by multiple layers of metamaterials, which absorbs and partially transmits such radiation, on top of a substrate of conventional electromagnetic- or sound-absorbing and partially reflecting material and inhibits the deformation, evaporation, sublimation or out gassing of this substrate material.

### BACKGROUND OF THE INVENTION

There exist a number of applications for a highly efficient absorber of electromagnetic or sound radiation especially in the microwave or ultrasonic frequency bands. The advent of metamaterials [MMs] has prompted the consideration or objective of creating perfectly “black” or totally absorbent material or structure. Such an objective, although not totally achievable, can be closely approximated. Electromagnetic metamaterials are artificially structured materials that are designed to interact with and control electromagnetic waves. Acoustic or sound metamaterials are artificially structured materials that are designed to interact with and control sound waves. One especially significant application of electromagnetic microwave-absorbing technology is for the detection of a small number of microwave photons in the presence of an intense beam in the background of microwave photons exhibiting the same frequency as the photons to be detected, a beam whose scattered or diffracted photons must be efficiently absorbed. An apparatus of that description is discussed in Peoples Republic of China Patent Number 01814223.0 and in Baker 2010, Woods, et al. 2011 and Baker 2011. This invention also relates to the construction of an anechoic chamber having highly absorbent walls such that only a negligibly small number of microwave photons or sound waves are reflected from the chamber's walls and the prevention of evaporation, sublimation or out gassing of the material in a substrate adjacent to the chamber walls. Other applications involve stealth aircraft, missiles and submarine craft and various acoustical systems.

### SUMMARY OF THE INVENTION

The general concept of the present invention is to utilize a primarily electromagnetic or sound radiation absorbing, but partially reflecting material substrate on the surface of which, facing the incident electromagnetic or sound radiation of any given wavelength to be absorbed, are applied an additional layer or layers of primarily electromagnetic or sound radiation absorbing but partially transmitting material that also presents a barrier or seal against the evaporation, sublimation or out gassing of the material comprising the substrate structure. A preferred embodiment involves the use of an electromagnetic or sound radiation absorbing substrate array of pyramidal foam absorbers; on the incident radiation-facing side of which a layer or layers of metamaterial electromagnetic or sound radiation absorbing material positioned substantially parallel to and at a predetermined distance from the substrate. Such pyramidal foam or other such absorbers may evaporate, sublimate or outgas in a hard-vacuum and/or low-temperature environment, but may be sealed from evaporation, sublimation or out gassing by the layers of metamaterials. The metamaterial layer or layers comprise a periodic pattern or patterns of conducting metallic inclusions deposited on the surface of a solid dielectric material or acoustical tiles similarly patterned. All layers and the substrate are designed for the absorption of the same electromagnetic or sound radiation frequency band or bands of any given wavelength.

### DESCRIPTION OF THE DRAWING

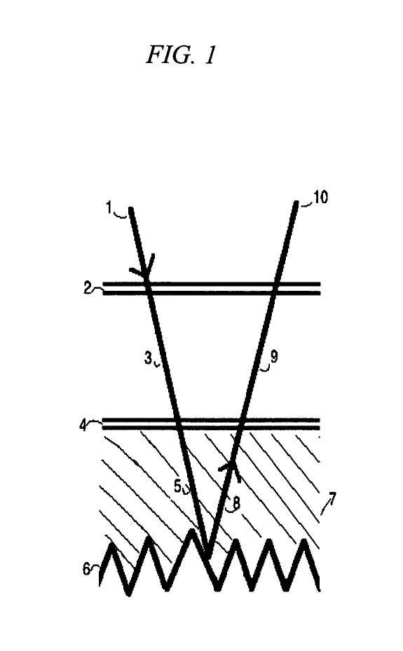

In FIG. 1 incident electromagnetic- or sound-radiation wave 1 reaches typical layer 2, partially transmitted electromagnetic- or sound-radiation wave 3 from layer 2 reaches typical layer 4, typical partially transmitted electromagnetic- or sound-radiation wave 5 from typical layer 4 reaches substrate 6 and is partially reflected as electromagnetic- or sound-radiation wave 8. Partially reflected as electromagnetic- or sound-radiation wave 8 reaches typical layer 4, typical partially transmitted electromagnetic- or sound-radiation wave 9 from typical layer 4 reaches typical layer 2 and the final partially transmitted remainder electromagnetic or sound wave 10 emerges from the structure. In FIG. 1 the multilayers consist two 2 and 4; but any number of such layers are possible. The incident ray 1 can have almost any inclination. As Service (2010) writes, “ . . . Sandia Laboratories in Albuquerque, N. Mex. are developing a technique to produce metamaterials [MMs] that work with [electromagnetic radiation] coming from virtually any direction.” Substrate layers 2 and 4 seal off substrate 6 from evaporating, sublimating or out gassing into the region above MM layer 2. The surface 6 of a substrate of acoustical tiles upon which the MM layers are deposited as well as the voids between one or more MM layers such as 4 and substrate 6 is filled with uniform or variable density'solid material such as dielectric material 7 in order to resist deformation of layer 4 and substrate 6 and seal the substrate surfaces 6 from evaporation, sublimation or out gassing of the material composing substrate 6 in the presence of a vacuum.

Whereas many alterations and modifications of the embodiments will no doubt become apparent to a person of ordinary skill in the art after having read the foregoing description and the following best means for carrying out, it is to be understood that the particular embodiments shown and described by way of illustration are in no way to be considered limiting. By way of example, while some embodiments are described in the context of negative-index materials, the feature and advantages of the embodiments are readily applicable in the context of other composite materials.

### BEST MEANS FOR CARRYING OUT THE INVENTION

As is well known, an electromagnetic wave incident on a surface is divided into a reflected and a transmitted wave. With a lossy surface, the incident electromagnetic wave is absorbed as it propagates such that the reflected and the transmitted wave together are less energetic than the incident wave. There exist certain surfaces, which comprise the substrate of the structure of the subject invention, that only reflect and do not transmit the incident radiation. There exist layers of other material that only transmit and do not reflect electromagnetic radiation due to their composition. When the inter-layer and substrate void is filled with solid material such as a dielectric plastic, evaporation, sublimation or out gassing of the substrate is inhibited and a vacuum or pressure difference among the layers and substrate will not deform the layers and substrate. Examples of the layers and substrates materials include, but are not limited to, the following:

Materials that only transmit or absorb and do not reflect electromagnetic or sound radiation have been developed and are defined as metamaterials or MMs. In the case of electromagnetic radiation they are constructed with a small, sub-wavelength dimensioned arrangement of conductors and dielectrics to affect various macroscopic optical behaviors. Such behaviors include negative indices of refraction and non-reflectivity in the case of electromagnetic radiation. Examples of such metamaterials are discussed in Landy, et al. (2008). They state: “In this study, we are interested in achieving (absorption) in a single unit cell in the propagation direction. Thus, our MM structure was optimized to maximize the (absorbance) with the restriction of minimizing the thickness. If this constraint is relaxed, impedance matching is possible, and with multiple layers, a perfect (absorbance) can be achieved.” As to the commercially available substrates or electromagnetic microwave absorbers that do reflect a small amount of radiation, there are several available that offer the required low reflectivity. For example, ARC Technologies, Cummings Microwave, the ETS Lindgren Rantec Microwave Absorbers or Anechoic Foam Wedges to mention only a few. The ETS Lindgren microwave pyramid absorbers are a preferred embodiment. At normal incidence the typical reflectivity is down −45 db (guarantied −40 db) according to their data sheets. As to the commercially available acoustic or sound absorbers, there are several available that offer the required low reflectivity. For example Sound Services, Ltd., Oxford, England, Sonex, USA, Acoustical Panels, Guangzhou Liyin Building Materials Co., Ltd., China to mention only a few. The Liyin sound-absorbing acoustic pyramids are preferred. Available acoustical metamaterials are described in Chen and Chan (2007).

What is claimed is:

1. A radiation absorbing structure comprising: a radiation absorbing and partially reflecting substrate on the surface of which is positioned a layer or layers of radiation absorbing and partially transmitting material such that incident radiation initially encounters the said layer or layers and the unabsorbed radiation passes through to an adjacent layer or layers and reaches the substrate and the unabsorbed radiation that is reflected by the said substrate passes back through the said layer or layers and is further absorbed.

2. A structure as recited in claim 1 in which the layers are separated by a distance that allows for the destructive interference of any radiation that remains unabsorbed.

3. A structure as recited in claim 1 in which the radiation is electromagnetic of any wavelength.

4. A structure as recited in claim 1 in which the radiation is sound of any wavelength.

5. A structure as recited in claim 1 in which the layer or layers of radiation absorbing and partially transmitting material form a barrier to seal the reflecting and absorbing substrate from a vacuum that prevents evaporation, sublimation or out gassing of the substrate of radiation absorbing and partially reflecting material.

6. A structure as recited in claim 5 in which the void between the layer or layers of radiation absorbing and partially transmitting material and the substrate of radiation absorbing and partially reflecting material is filled with a solid material.
